(19) United States
(12) Patent Application Publication
(10) Pub. No.: US 2004/0268082 A1
(43) Pub. Date: Dec. 30, 2004

(54) Method and system for parcel-based data mapping

(76) Inventors: Michael Yatziv, Saratoga, CA (US); Satyanarayana Nishtala, Cupertino, CA (US); Whay Sing Lee, Newark, CA (US); Raghavendra J. Rao, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/608,311

(22) Filed: Jun. 27, 2003

(51) Int. Cl. G06F 12/08

(52) U.S. Cl. 711/203; 711/171

(57) ABSTRACT

Embodiments of the invention provide a parcel-based, data-mapping scheme that allow for implementation of data integrity methods and variable size logical data blocks while the layout of the physical storage device remains unchanged. For one embodiment, the invention provides a method in which a virtual data storage parcel including a number of extended-size logical data storage blocks is created, and one or more physical data storage parcels, each including a number of standard-size logical data storage blocks, is created. The combined size of the one or more physical data storage parcels equals or exceeds the size of the virtual data storage parcel. The extended-size logical data storage blocks of the virtual data storage parcel are mapped to the standard-size logical data storage blocks of the one or more physical data storage parcels.

### CROSS-REFERENCE TO RELATED APPLICATION

This application is related to co-pending Patent Application Number TBD, entitled “P8522 Title,” filed “same date as this one,” which is commonly assigned with the present invention.

### FIELD

Embodiments of the invention relate generally to the field of data storage systems and more particularly to addressing the problem data corruption of stored data.

### BACKGROUND

Typical large-scale data storage systems today include one or more dedicated computers and software systems to manage data. A primary concern of such data storage systems is that of data corruption and recovery. Data corruption may be physical (e.g., due to damage of the physical storage medium) or logical (due to errors (“bugs”) in the embedded software). Embedded software bugs may cause data corruption in which the data storage system returns erroneous data and doesn't realize that the data is wrong. This is known as silent data corruption. Silent data corruption may also result from hardware failures, such as a malfunctioning data bus or corruption of the magnetic storage media, that may cause a data bit to be inverted or lost. Silent data corruption may also result from a variety of other causes. In general, the more complex the data storage system, the more possible causes of silent data corruption.

Silent data corruption is particularly problematic. For example, when an application requests data and gets the wrong data this may cause the application to crash. Additionally, the application may pass along the corrupted data to other applications. If left undetected, these errors may have disastrous consequences (e.g., irreparable, undetected, long-term data corruption).

The problem of detecting silent data corruption is addressed by creating redundancy data for each data block. Redundancy data may include error correction codes (“ECC”s) or cyclic redundancy checks (“CRC”s) or other error detection schemes, such as checksums, to verify the contents of a data block.

The issue of where to store the redundancy data arises. As an example, the redundancy data may require 8-28 bytes for each standard 512-byte data block. Typical data storage systems using block-based protocols (e.g., SCSI) store data in blocks of 512 bytes in length so that all input/output (I/O) operations take place in 512-byte blocks (sectors). One approach is to extend the block so that the redundancy data may be included with the system data. In some systems a physical block on the drive can be formatted as a larger size. So, instead of data blocks of 512 bytes in length, the system will now use data blocks of, for example, 520 or 540 bytes in length depending on the size of the redundancy data. The redundancy data will be cross-referenced with the actual data at the host controller. For this to be feasible, the size of the logical data block as seen by the software has to remain the same (e.g., 512 bytes), but the size of the physical block has to be increased to accommodate the redundancy data. This concept of formatting larger sectors can be implemented for some systems (e.g., those using SCSI drives).

However, not all systems use drives that allow formatting larger sectors; ATA drives, for example, can have only 512-byte blocks. That is, they cannot be reformatted. Moreover, such a solution is often cost prohibitive because increasing the physical block size may require special purpose operations or equipment. That is, the extended data block method requires that every component of the data storage system from the processing system, through a number of operating system software layers and hardware components, to the storage medium, be able to accommodate the extended data block. Data storage systems are frequently comprised of components from a number of manufacturers. For example, while the processing system may be designed for an extended block size, it may be using software that is designed for a 512-byte block. Additionally, for large existing data stores that use a 512-byte data block, switching to an extended block size may require unacceptable transition costs and logistical difficulties.

### SUMMARY

A method and system for parcel-based data mapping is provided. A virtual data storage parcel, including a number of virtual logical data storage blocks of a first size, is created. One or more physical data storage parcels, each including a number of physical logical data storage blocks of a second size, is created. The virtual logical data storage blocks of the virtual data storage parcel are mapped to the physical logical data storage blocks of the one or more physical data storage parcels.

Other features and advantages of embodiments of the present invention will be apparent from the accompanying drawings and from the detailed description that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a mapping of a virtual data storage parcel to a physical data storage parcel for a data storage system using a standard data block size of 512 bytes in length in accordance with one embodiment of the present invention;

FIG. 2 illustrates a process by which logical data blocks of a virtual data storage parcel are mapped to logical data blocks of a physical data storage parcel in accordance with one embodiment of the invention; and

FIG. 3 illustrates an exemplary data storage system in accordance with an embodiment of the present invention.

### DETAILED DESCRIPTION

### Overview

Embodiments of the invention provide a data-mapping scheme that allows for implementation of data integrity methods and variable size logical data blocks while the layout of the physical storage device remains unchanged. The arrangement of the variable size logical data blocks can be characterized as a parcel. A parcel is the smallest movable contiguous storage unit in the storage subsystem and provides support for various data integrity schemes and for exporting non-standard data block sizes in a heterogeneous environment.

For one embodiment, the invention provides a method for storing redundancy data for data blocks by increasing logical data block size while retaining a specified physical data block size. For one embodiment, a virtual data storage parcel containing a number of consecutive logical data blocks is created. The logical data blocks of the virtual data storage parcel are larger than the specified size of the physical blocks and may thus contain the redundancy data. The virtual data storage parcel is created through a mapping of one or more atomic physical data storage parcels. Each physical data storage parcel consists of a number of consecutive logical data blocks with each logical data block being the specified size of the physical blocks. The physical data storage parcel contains more logical data blocks than the corresponding virtual data storage parcel. For one embodiment, one physical data storage parcel consisting of nine logical data blocks of 512 bytes is mapped to one virtual data storage parcel consisting of eight logical data blocks of 540 bytes, with the remaining bytes of the physical data storage parcel available to store, for example, redundancy information pertaining to the virtual data storage parcel.

In the following description, numerous specific details are set forth. However, it is understood that embodiments of the invention may be practiced without these specific details. In other instances, well-known structures and techniques have not been shown in detail. Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Similarly, it should be appreciated that in the following description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

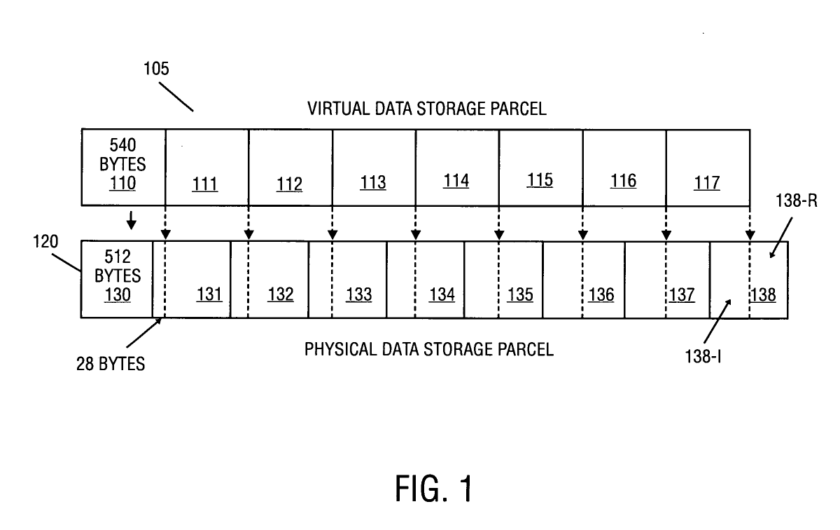

FIG. 1 illustrates a mapping of a virtual data storage parcel to a physical data storage parcel for a data storage system using a standard data block size of 512 bytes in length in accordance with one embodiment of the present invention. Virtual data storage parcel 105, shown in FIG. 1, includes eight extended logical data blocks 110-117. Each extended logical data block of virtual data storage parcel 105 is 540 bytes in length. For alternative embodiments, the number of extended logical data blocks in a virtual data storage parcel may vary. Moreover, the length of each logical data block may vary and may, for one embodiment, be equal to the data storage system's standard block length. That is, the extended logical data block size may vary depending upon the amount of data (e.g., redundancy data) to be attached to each extended logical data block.

Extended logical data blocks 110-117 are mapped to nine standard logical data blocks 130-138 of physical data storage parcel 120. Standard logical data blocks 130-138 are each 512 bytes in length. For alternative embodiments, the number of standard logical data blocks in the physical data storage parcel may vary, as may the size of the standard logical data block. The first 512 bytes of the 540 bytes of extended logical data block 110 are mapped into the 512 bytes of standard logical data block 130. The remaining 28 bytes of extended logical data block 110 are mapped into the first 28 bytes of the 512 bytes of standard logical data block 131. The first 484 bytes of extended logical data block 111 are mapped into the remaining 484 bytes of standard logical data block 131, and the remaining 56 bytes of extended logical data block 111 are mapped into the first 56 bytes of standard logical data block 132. The process is continued until all of the extended logical data blocks 110-117 of virtual data storage parcel 105 are mapped into the standard logical data blocks 130-138 of physical data storage parcel 120. Upon completion of mapping, standard logical data block 138 will have data stored in the initial 224 bytes labeled 138-I, the remaining 288 bytes, labeled 138-R, may be used to store redundancy or other data pertaining to the entire physical data storage parcel 120.

### Process

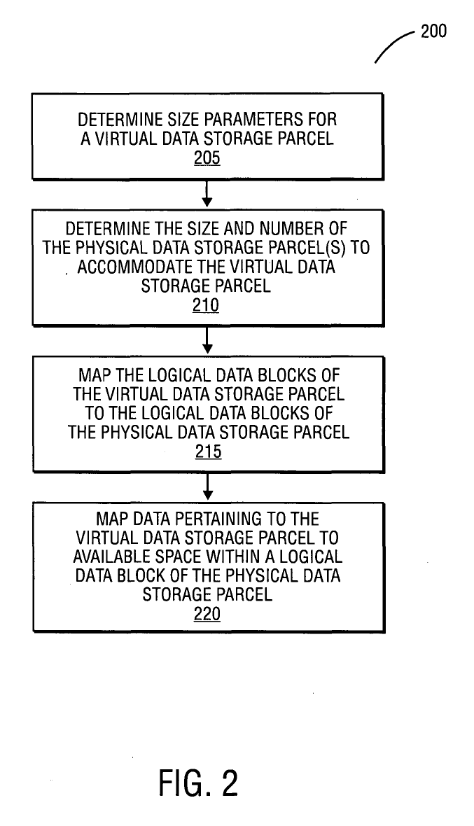

FIG. 2 illustrates a process by which logical data blocks of a virtual data storage parcel are mapped to logical data blocks of a physical data storage parcel in accordance with one embodiment of the invention. Process 200 begins with operation 205 in which the size parameters for a virtual data storage parcel are determined. That is the number of logical data blocks and the size of each logical data block are determined. As described above, the size of each logical data block may vary according to policy and is determined by the mapping algorithm. In accordance with various embodiments, the size of each logical data block may vary by subsystem, storage space, virtual logical unit, or extent.

At operation 210 the size of the physical data storage parcel or parcels to accommodate the virtual data storage parcel is determined. One virtual data storage parcel may be backed by any integer number of physical data storage parcels. The number of physical data storage parcels corresponding to a virtual data storage parcel, and hence the size of each physical data storage parcel, is determined by considering the competing concerns of size overhead and performance overhead.

At operation 215 the logical data blocks of the virtual data storage parcel are mapped to the logical data blocks of the physical data storage parcel. If the size of the logical data blocks of the virtual data storage parcel is extended beyond the size of a standard data block, then block-level redundancy data or other data pertaining to the block is mapped to the excess storage space of each logical data block. For one embodiment, the size of the logical data blocks of the virtual data storage parcel and the number of standard-size blocks of the physical data storage parcel (and in consequence the number of physical data storage parcels), are chosen so as to create a redundancy block. For example, they may be chosen such that one of the standard-size blocks in one of the physical data storage parcels has remaining storage space after the logical data blocks of the virtual data storage parcel are mapped to the logical data blocks of the physical data storage parcels. This standard-size data block functions as the redundancy block.

At operation 220 parcel level redundancy data, or other data pertaining to the virtual data storage parcel, is mapped to the physical data storage parcel in the remaining bytes of the redundancy data block.

### System

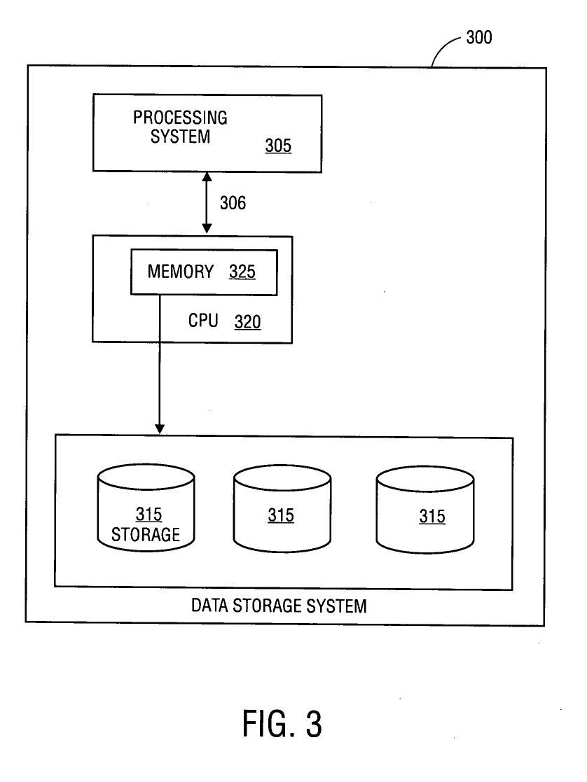

FIG. 3 illustrates an exemplary data storage system in accordance with an embodiment of the present invention. The parcel-based data mapping method of the present invention may be implemented on the data storage system shown in FIG. 3. The data storage system 300 shown in FIG. 3 contains one or more mass storage devices 315 that may be magnetic or optical storage media. Data storage system 300 also contains one or more internal processors, shown collectively as the CPU 320. The CPU 320 may include a control unit, arithmetic unit and several registers with which to process information. CPU 320 provides the capability for data storage system 300 to perform tasks and execute software programs stored within the data storage system. The process of parcel-based data mapping in accordance with the present invention may be implemented by hardware and/or software contained within the data storage device 300. For example, the CPU 320 may contain a memory 325 that may be random access memory (“RAM”) or some other machine-readable medium, for storing program code (e.g., parcel-based mapping software) that may be executed by CPU 320. The machine-readable medium may include a mechanism that provides (i.e., stores and/or transmits) information in a form readable by a machine such as a computer or a digital processing device. For example, a machine-readable medium may include a read only memory (“ROM”), RAM, magnetic disk storage media, optical storage media and flash memory devices. The code or instructions may be represented by carrier-wave signals, infrared signals, digital signals and by other like signals.

For one embodiment, the data storage system 300 shown in FIG. 3 may include a processing system 305 (such as a PC, workstation, server, mainframe or host system). Users of the data storage system may be connected to the processing system 305 via a local area network (not shown). The CPU 320 communicates with the processing system 305 via a bus 306 that may be a standard bus for communicating information and signals and may implement a block-based protocol (e.g., SCSI or fibre channel). The CPU 320 is capable of responding to commands from processing system 305.

It is understood that many alternative configurations for a data storage system in accordance with alternative embodiments are possible. For example, the embodiment shown in FIG. 3 may, in the alternative, have the parcel-based mapping software implemented in the processing system. The parcel-based mapping software may alternatively be implemented in the host system.

### General Matters

Embodiments of the invention may be applied to provide a parcel-based, data-mapping scheme that allows for implementation of data integrity methods and variable size logical data blocks while the layout of the physical storage device remains unchanged. A parcel is the smallest movable contiguous storage unit in the storage subsystem and provides support for various data integrity schemes and for exporting non-standard data block size in heterogeneous environment.

For one embodiment, the invention provides a method for storing redundancy data for data blocks by increasing logical data block size while retaining a specified physical block size. For one embodiment, a virtual data storage parcel containing a number of consecutive logical data blocks is created. The logical data blocks of the virtual data storage parcel are larger than the specified size of the physical blocks and may thus contain the redundancy data. The virtual data storage parcel is created through a mapping of one or more physical data storage parcels. As discussed above, the physical data storage parcels are the atomic I/O operation units. That is, the scope of each Read or Write operation in the storage subsystem is an integral number of physical data storage parcels. Each physical data storage parcel consists of a number of consecutive logical data blocks, with each logical data block being the specified size of the physical blocks. The physical data storage parcel contains more logical data blocks than the virtual data storage parcel.

As described above in reference to operation 210, the number of physical data storage parcels corresponding to a virtual data storage parcel, and hence the size of each physical data storage parcel, is determined by considering the competing concerns of size overhead and performance overhead. For example, the physical data storage parcel has at least one standard-size data block to include the physical data storage parcel level redundancy data. Therefore a physical data storage parcel consisting of five standard-size data blocks will have a size overhead of 25%. A physical data storage parcel consisting of seventeen standard-size data blocks will have a size overhead of only approximately 6%. On the other hand, because the physical data storage parcel is operated on atomically (i.e., the entire physical data storage parcel is read from or written to in a single I/O operation), a physical data storage parcel consisting of fewer standard-size data blocks will have a proportionately lower performance overhead.

For one embodiment, the virtual data storage parcel consists of eight logical data blocks each having an amount of block-level redundancy data, typically from 8-20 bytes. The corresponding physical data storage parcel consists of nine standard-size data blocks of 512 bytes. This provides enough data storage to accommodate the extended logical data blocks of the virtual data storage parcel and accommodate parcel-level redundancy data.

In alternative embodiments, the physical data storage parcel may include, for example, redundancy data and/or other special use data such as time stamp data, use attribute data, statistical data, or cache history data. Such data may be implemented as block-level data and parcel-level data.

Alternative embodiments of the method of the present invention may be implemented anywhere within the block-based portion of the I/O datapath. The datapath includes all software, hardware, or other entities that manipulate the data from the time that it enters block form on write operations to the point where it leaves block form on read operations. The datapath extends from the computer that reads or writes the data (converting it into block form) to the storage device where the data resides during storage. For example, the datapath includes software modules that stripe or replicate the data, the disk arrays that store or cache the data blocks, the portion of the file system that manages data in blocks, the network that transfers the blocks, etc.

The invention includes various operations. It will be apparent to those skilled in the art that the operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. As discussed above, the invention may be provided as a computer program product that may include a machine-readable medium having stored thereon instructions that may be used to program a computer (or other electronic devices) to perform a process according to the invention.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
creating a virtual data storage parcel, the virtual data storage parcel including a number of virtual logical data blocks of a first size;
creating one or more physical data storage parcels, each of the one or more physical data storage parcels including a number of physical logical data blocks of a second size; and
mapping the virtual logical data blocks to the physical logical data storage blocks.

2. The method of claim 1 wherein a combined size of the one or more physical data storage parcels exceeds the size of the virtual data storage parcel, the method further comprising:
storing data pertaining to the virtual data storage parcel in one or more of the physical logical data blocks.

3. The method of claim 2 wherein the data pertaining to the physical data storage parcels includes data of one or more types selected from the list consisting of error correction code data, cyclic redundancy check data, checksum data, timestamp data and cache history data.

4. The method of claim 3 wherein each virtual logical data block includes system data as well as data pertaining to the system data of the respective virtual logical data block.

5. The method of claim 4 wherein the data pertaining to the virtual logical data block includes data of one or more types of data selected from the list consisting of error correction code data, cyclic redundancy check data, checksum data, timestamp data and cache history data.

6. The method of claim 1 wherein the virtual data storage parcel includes eight virtual logical data blocks, the eight virtual logical data blocks mapped to a physical data storage parcel including nine physical logical data storage blocks.

7. The method of claim 6 wherein the nine physical logical data blocks are 512 bytes in length.

8. The method of claim 1 wherein the size of each virtual logical data block varies within a data storage system.

9. The method of claim 1 further comprising:
determining a number of physical data storage parcels based upon consideration of size overhead and performance overhead.

10. A data storage system comprising:
a storage medium;
a processing system; and
a memory, coupled to the processing system, the memory having stored therein instructions which, when executed by the processing system, cause the processing system to a) create a virtual data storage parcel, the virtual data storage parcel including a number of virtual logical data storage blocks of a first size, b) create one or more physical data storage parcels, each of the one or more physical data storage parcels including a number of physical logical data storage blocks of a second size, and c) map the virtual logical data storage blocks to the physical logical data storage blocks.

11. The data storage system of claim 10 wherein a combined size of the one or more physical data storage parcels exceeds the size of the virtual data storage parcel, and wherein the instructions which, when executed by the processing system, further cause the processing system to d) store data pertaining to the virtual data storage parcel in one or more of the physical logical data blocks.

12. The data storage system of claim 10 wherein the data pertaining to the physical data storage parcels includes data of one or more types selected from the list consisting of error correction code data, cyclic redundancy check data, checksum data, timestamp data and cache history data.

13. The data storage system of claim 12 wherein each virtual logical data block includes system data as well as data pertaining to the system data of the respective virtual logical data block.

14. The data storage system of claim 13 wherein the data pertaining to the virtual logical data block includes data of one or more types of data selected from the list consisting of error correction code data, cyclic redundancy check data, checksum data, timestamp data and cache history data.

15. The data storage system of claim 10 wherein the virtual data storage parcel includes eight virtual logical data blocks, the eight virtual logical data blocks mapped to a physical data storage parcel including nine physical logical data storage blocks.

16. The data storage system of claim 15 wherein the nine physical logical data blocks are 512 bytes in length.

17. The data storage system of claim 10 wherein the size of each virtual logical data block varies within the data storage system.

18. The data storage system of claim 10 wherein the instructions which, when executed by the processing system, further cause the processing system to e) determine a number of physical data storage parcels based upon consideration of size overhead and performance overhead.

19. A machine-readable medium containing instructions which, when executed by a processing system, cause the processing system to perform a method, the method comprising:
creating a virtual data storage parcel, the virtual data storage parcel including a number of virtual logical data storage blocks of a first size;
creating one or more physical data storage parcels, each of the one or more physical data storage parcels including a number of physical logical data storage blocks of a second size; and
mapping the virtual logical data storage blocks to the physical logical data storage blocks.

20. The machine-readable medium of claim 19 wherein a combined size of the one or more physical data storage parcels exceeds the size of the virtual data storage parcel, the method further comprising:
storing data pertaining to the virtual data storage parcel in one or more of the physical logical data blocks.

21. The machine-readable medium of claim 20 wherein the data pertaining to the physical data storage parcels includes data of one or more types selected from the list consisting of error correction code data, cyclic redundancy check data, checksum data, timestamp data and cache history data.

22. The machine-readable medium of claim 21 wherein each virtual logical data block includes system data as well as data pertaining to the system data of the respective virtual logical data block.

23. The machine-readable medium of claim 22 wherein the data pertaining to the virtual logical data block includes data of one or more types of data selected from the list consisting of error correction code data, cyclic redundancy check data, checksum data, timestamp data and cache history data.

24. The machine-readable medium of claim 19 wherein the virtual data storage parcel includes eight virtual logical data blocks, the eight virtual logical data blocks mapped to a physical data storage parcel including nine physical logical data storage blocks.

25. The machine-readable medium of claim 24 wherein the nine physical logical data blocks are 512 bytes in length.

26. The machine-readable medium of claim 19 wherein the size of each logical data block varies within a data storage system.

27. The machine-readable medium of claim 19 wherein the method further comprises:
determining a number of physical data storage parcels based upon consideration of size overhead and performance overhead.
